(19) United States
(12) Patent Application Publication
(10) Pub. No.: US 2026/0138589 A1
(43) Pub. Date: May 21, 2026

(54) METHOD FOR OPERATING A HYBRID DRIVE SYSTEM, AND MOTOR VEHICLE

(71) Applicant: Volkswagen Aktiengesellschaft, Wolfsburg (DE)

(72) Inventors: Stephan KRAUS, Wolfsburg (DE); Johannes BUNKUS, Wolfsburg (DE)

(73) Assignee: Volkswagen Aktiengesellschaft, Wolfsburg (DE)

(21) Appl. No.: 19/392,683

(22) Filed: Nov. 18, 2025

(30) Foreign Application Priority Data
Nov. 18, 2024 (DE) 10 2024 133 667.6

(51) Int. Cl. B60W 20/16; B60W 20/13; F02D 41/02

(52) U.S. Cl. CPC B60W 20/16; B60W 20/13; F02D 41/027; B60W 2510/244; F02D 2200/503

(57) ABSTRACT

A method for operating a hybrid drive system of a motor vehicle. The hybrid drive system can have an internal combustion engine and an electric machine. A control device of the motor vehicle provides a buffer between a present effective current value of a battery current of a traction battery of the motor vehicle and a third current limit value of the traction battery so that the third current limit value is not exceeded during a regeneration process for an exhaust emission control device of the motor vehicle. A motor vehicle that is designed to carry out the method is also provided.

This nonprovisional application claims priority under 35 U.S.C. § 119(a) to German Patent Application No. 10 2024 133 667.6, which was filed in Germany on Nov. 18, 2024, and which is herein incorporated by reference.

### BACKGROUND OF THE INVENTION

### Field of the Invention

The present invention relates to a method for operating a hybrid drive system of a motor vehicle. The invention further relates to a motor vehicle that is designed to carry out a method according to the invention.

### Description of the Background Art

Hybrid drive systems for motor vehicles are known in which an internal combustion engine and an electric machine are provided for the drive of the motor vehicle. These types of hybrid drive systems have a traction battery for operating the electric machine.

During operation, traction batteries are subject to aging, the rate of which is dependent on operating parameters of the traction battery, for example a state of charge, an effective battery current, a battery temperature, or the like. The effective battery current is a surrogate parameter for determining a degree of load on an electrical system, since electrical components may temporarily provide power or current that is greater than their continuous output. An effective battery current can be understood to mean an average value of an absolute value of current, sometimes also referred to as “root mean square current,” “RMS current,” or “IRMS.”

Numerous different measures are known for preventing excessive aging or for protecting the traction battery, such as targeted temperature control of the traction battery, avoidance of an excessively high or excessively low state of charge of the traction battery, in particular after a fairly long period of inactivity of the motor vehicle, or limitation of the maximum allowable effective battery current.

For an excessively high battery temperature, the temperature control may encompass, for example, targeted cooling of the traction battery, and for an excessively low battery temperature may encompass, for example, targeted heating of the traction battery, so that the traction battery is always operated within a predefined temperature range and is thus subject to less aging.

An excessively high state of charge of the traction battery may, for example, facilitate irreversible side reactions in the traction battery, as a result of which the overall capacity of the traction battery may be reduced. For an excessively low state of charge there may be a threat of total discharge of the traction battery, which may likewise cause irreversible damage to the traction battery. By targeted activation of consumers or by targeted charging or discharging of the traction battery via an external charging device or the like, the state of charge of the traction battery may be manipulated in a targeted manner in such a way that the aging of the traction battery is minimized. Methods for operating drive systems with active limitation of the state of charge of the traction battery are known from the documents DE 10 2019 202 210 A1 and KR 10 2020 004 0012 A, for example.

As a result of limiting the maximum allowable effective battery current, current limits are defined which during operation of the motor vehicle cannot be exceeded, or which cannot be exceeded for a few seconds at most, so that the traction battery is always operated in a particularly battery-protecting manner.

Problematic battery currents may occur in particular when the motor vehicle is moving at a low speed, for example 50 km/h or less, and a regeneration process of an exhaust emission control device of the motor vehicle, for example a catalytic converter, a particulate filter, or the like, is to be carried out. For achieving the exhaust gas temperatures necessary for this purpose, the power of the internal combustion engine at the time is not sufficient, so that applying a load to the internal combustion engine is necessary for successfully carrying out the regeneration process.

When load is applied, the internal combustion engine is operated with higher torque than is required for the drive of the motor vehicle. The excess torque is then used to drive the electric machine for generating electrical current. By use of this measure, the battery current may be increased in such a way that the predefined current limit value is exceeded, so that excessive aging or even direct damage to the traction battery may result.

### SUMMARY OF THE INVENTION

It is therefore the object of the present invention to eliminate, at least in part, the above-described disadvantages with a method for operating a hybrid drive system of a motor vehicle. In particular, it is the object of the present invention to provide a method for operating a hybrid drive system of a motor vehicle and a motor vehicle having a hybrid drive system, which avoid overload of the traction battery in a simple and cost-effective manner and thus have a reduced aging rate of the traction battery.

According to an example of the invention, the object is achieved by a method for operating a hybrid drive system of a motor vehicle. The method can comprise: recognition of an imminent regeneration of an exhaust emission control device of the motor vehicle by a control device of the motor vehicle, determination of a present effective current value of a battery current of a traction battery of the motor vehicle by the control device, targeted reduction of the effective current value of the battery current to below a first current limit value by the control device when the present effective current value exceeds a second current limit value, carrying out the regeneration of the exhaust emission control device by operation of the internal combustion engine by the control device in such a way that as a result of the effective current value of the battery current a third current limit value is not exceeded, the third current limit value being higher than the second current limit value, ending the regeneration of the exhaust emission control device by the control device, and ending the targeted reduction of the effective current value of the battery current by the control device.

The method according to the invention for operating a hybrid drive system of a motor vehicle may be carried out, for example, with a motor vehicle that is designed as a full hybrid vehicle, mild hybrid vehicle, or plug-in hybrid vehicle. The internal combustion engine is designed to provide a drive torque for the drive of the motor vehicle. The electric machine, for example, an electric drive, is designed at least to convert kinetic energy into electrical energy. The electric machine is preferably additionally designed to assist the internal combustion engine for the drive of the motor vehicle, for example, directly or via a generator. According to the invention, it may be provided that the electric machine is designed to drive the motor vehicle without assistance from the internal combustion engine. The traction battery is designed to store and provide electrical energy.

The control device of the motor vehicle recognizes the imminent regeneration of the exhaust emission control device of the motor vehicle. Imminent regeneration of the exhaust emission control device can be understood to mean that the regeneration of the exhaust emission control device is to take place at a certain future point in time while the motor vehicle is traveling. While the motor vehicle is traveling, the point in time of the imminent regeneration may be determined, for example, by detecting a trigger criterion such as the differential pressure across the catalytic converter/particulate filter, a cumulative operating period, a number of kilometers traveled, an exhaust gas measurement, or the like. Alternatively, the control device may determine the imminent regeneration, for example, also in the parked state of the motor vehicle.

In addition, the control device determines the present effective current value of the battery current (IRMS) of the traction battery of the motor vehicle. This preferably takes place during operation of the motor vehicle, for example during travel or when the motor vehicle is briefly stopped, for example at a traffic light, at a stop sign, or in a traffic jam. The present effective current value of the battery current is a function of the power of the consumers that are supplied by the traction battery, and of the electric machine during charging of the traction battery in generator mode.

When the present effective current value determined by the control device exceeds the second current limit value, the control device reduces the effective current value of the battery current to below the first current limit value. The reduction of the effective current value of the battery current may take place, for example, by switching off or down-regulating one or more consumers or hybrid driving functions of the motor vehicle. Auxiliary consumers that are not necessary for proper operation of the motor vehicle in road traffic are preferred. More preferably, the reduction of the effective current value of the battery current may take place, for example, by deactivating one or more special operating modes of the motor vehicle which may cause an increase in the effective current value of the battery current. The reduction of the effective current value of the battery current takes place in a timely manner before the regeneration of the exhaust emission control device is carried out, so that a buffer is provided between the effective current value of the battery current and the third current limit value. The first current limit value is selected in such a way that the buffer is only partially used up during the regeneration of the exhaust emission control device, for example due to applying load to the internal combustion engine and the associated higher generator power of the electric machine. The first current limit value is preferably determined as a function of a vehicle speed and/or ambient temperature and/or component temperature of a component of the motor vehicle. The component temperature may be, for example, a temperature of the exhaust emission control device and/or of the internal combustion engine. The second current limit value is preferably selected in such a way that the buffer is partially to completely used up during the regeneration of the exhaust emission control device. The second current limit value is greater than the first current limit value. The third current limit value may correspond, for example, to a maximum allowable current limit value of the hybrid drive system. Accordingly, the third current limit value is greater than the second current limit value.

The regeneration of the exhaust emission control device is subsequently carried out by the control device. The regeneration is preferably carried out for an exhaust emission control device designed as a particulate filter and/or catalytic converter. For the regeneration, the internal combustion engine is operated by the control device in such a way that a predefined exhaust gas temperature for the regeneration is provided. The control device monitors that the third current limit value, which is higher than the second current limit value, is not exceeded. Thus, during the regeneration process an overload of the traction battery is avoided and a regeneration of the exhaust emission control device is ensured.

When the exhaust emission control device is completely, predominantly, or at least partially regenerated, the control device ends the regeneration process. With a relatively large buffer the regeneration preferably takes place completely. With a relatively medium-sized buffer the regeneration preferably takes place until the exhaust emission control device is predominantly regenerated in order to avoid an overload of the traction battery. With a relatively small buffer the regeneration preferably takes place until the exhaust emission control device is at least partially regenerated in order to avoid an overload of the traction battery and to continue to ensure proper cleaning of the exhaust gases from the internal combustion engine. A complete regeneration may take place at a later point in time, for example, when the buffer is once again larger.

Lastly, the control device ends the targeted reduction of the battery current. The control device preferably ensures that the third current limit value is not exceeded by the battery current. Ending the targeted reduction of the battery current may take place during or after the regeneration, depending on the battery current load at the time, preferably always avoiding an exceedance of the third current limit value.

A method according to the invention for operating a hybrid drive system of a motor vehicle has the advantage over conventional methods that regeneration of the exhaust emission control device may be carried out in a cost-effective manner using simple means, without causing an overload of the traction battery. This is particularly advantageous at a relatively low vehicle speed, for example 40 km/h, 30 km/h, or less, since the exhaust gas temperature thus generated is usually not sufficient for the regeneration, so that it is necessary to apply load to the internal combustion engine. As a result of temporarily refraining from use of the consumers, a power quota is thus reserved for the regeneration, so that an overload of the traction battery due to high battery currents is avoided. In this way, decreased capacity of the traction battery may be lessened, and the service life of the traction battery may be prolonged.

A first current limit value can be used which is less than or equal to the second current limit value. For a first current limit value that corresponds to the second current limit value, for example only the operation of auxiliary consumers is prevented or at least limited. For a first current limit value that is less than the second current limit value, for example the operation of one or more auxiliary consumers is curtailed, so that the present effective current value of the battery current is reduced. This has the advantage that reliable regeneration of the exhaust emission control device is provided, and an overload of the traction battery due to excessively high battery currents is avoided, in a cost-effective manner using simple means.

A second current limit value can be used which corresponds to between 50% and 75% of the third current limit value. A second current limit value is preferably used which corresponds to between 60% and 70% of the third current limit value. This ensures that a buffer of at least 25% of the allowable current limit value is provided for the regeneration of the exhaust emission control device, for example for applying load to the internal combustion engine. This has the advantage that reliable regeneration of the exhaust emission control device is provided, and an overload of the traction battery due to excessively high battery currents is avoided, in a cost-effective manner using simple means.

More preferably, for the targeted reduction of the effective current value of the battery current by the control device, a recuperation can be completely or at least partially prevented when a state of charge (SOC) of the traction battery is greater than a predefined state of charge threshold value of the traction battery. For a severely discharged traction battery, for example, the electrical energy recovered during the recuperation may often be fed fairly easily into the traction battery. For a completely or at least essentially completely charged traction battery, the capacity of the traction battery for the electrical energy recovered during the recuperation is less. In addition, traction batteries having a higher SOC heat up more quickly than those with a lower SOC, so that there is a dependency between the third current limit value and the SOC. This has the advantage that reliable regeneration of the exhaust emission control device is provided, and an overload of the traction battery due to excessively high battery currents is avoided, in a cost-effective manner using simple means.

For the targeted reduction of the effective current value of the battery current, a load point shift of the internal combustion engine may be completely or at least partially suppressed by the control device. A load point shift can be understood to mean that the internal combustion engine is operated in a targeted manner in an operating range having at least one benefit, such as particularly low fuel consumption, particularly low emissions, or the like. This operating range differs from a natural operating range of the internal combustion engine for movement of the motor vehicle. To avoid an effect on the performance of the motor vehicle, this difference may be compensated for, for example, by the electric machine, for example by means of a generator mode or provision of an additional drive torque. This has the advantage that reliable regeneration of the exhaust emission control device is provided, and an overload of the traction battery due to excessively high battery currents is avoided, in a cost-effective manner using simple means.

For the targeted reduction of the effective current value of the battery current, a transient compensation of the electric machine for the internal combustion engine is preferably completely or at least partially suppressed by the control device. A transient compensation can be understood to mean assistance of the internal combustion engine by the electric machine during acceleration of the motor vehicle. Internal combustion engines, in particular in the low rotational speed range, always require some time to reach a rotational speed range in which they provide their maximum drive torque. A driver of the motor vehicle who presses down on the accelerator pedal for acceleration experiences a “dead time” in which the motor vehicle does not accelerate, or accelerates more slowly than in an optimal rotational speed range of the internal combustion engine. By use of the electric machine this dead time may be overcome, so that the motor vehicle may be uniformly accelerated, even at low rotational speeds of the internal combustion engine. The activation of the electric machine brings about a higher battery current, so that the battery load is increased. To allow a sufficient buffer for the regeneration, it may therefore be advantageous to at least temporarily do without the comfort of the transient compensation. This has the advantage that reliable regeneration of the exhaust emission control device is provided, and an overload of the traction battery due to excessively high battery currents is avoided, in a cost-effective manner using simple means.

The first current limit value can be determined by the control device as a function of traffic data in the surroundings of the motor vehicle. The traffic data may be provided, for example, from a server, a cloud, a sensor system of the motor vehicle, directly from other motor vehicles, or the like. The traffic data may include, for example, a traffic flow, a traffic density, the number of road users in the vicinity of the motor vehicle and/or on the further route of the motor vehicle that is relevant for the regeneration. In addition, the traffic data may include information concerning road conditions, speed limits, construction sites, hazardous areas, or the like. Future vehicle speeds may be estimated by use of the traffic data, and it is thus possible to determine a necessary buffer for the regeneration of the exhaust emission control device, for example a required interval between the first current limit value and the third current limit value. At expected higher speeds for which there may be little or no need to apply load to the internal combustion engine, this buffer may be smaller than at lower speeds that require greater application of load for the regeneration. This has the advantage that reliable regeneration of the exhaust emission control device is provided, and an overload of the traction battery due to excessively high battery currents is avoided, in a cost-effective manner using simple means.

The first current limit value can be determined by the control device as a function of data from a navigation system of the motor vehicle. By use of the data from the navigation system, it is likewise possible to estimate future vehicle speeds and thus determine a required buffer for the regeneration of the exhaust emission control device. This has the advantage that reliable regeneration of the exhaust emission control device is provided, and an overload of the traction battery due to excessively high battery currents is avoided, in a cost-effective manner using simple means.

The first current limit value can be determined by the control device as a function of driving statistics of the motor vehicle and/or of a driver of the motor vehicle. For this purpose, for example a present driving mode of the driver, for example since the start of travel, may be used. Alternatively or additionally, for this purpose a previous applied user profile of the driver may be evaluated. This has the advantage that reliable regeneration of the exhaust emission control device is provided, and an overload of the traction battery due to excessively high battery currents is avoided, in a cost-effective manner using simple means.

According to a second aspect of the invention, the object is achieved by a motor vehicle. The motor vehicle can have a hybrid drive system with an internal combustion engine for the drive of the motor vehicle, and an electric machine for the drive of the motor vehicle. According to the invention, the motor vehicle is designed to carry out a method according to the invention. The motor vehicle according to the invention results in all advantages that have already been described concerning a method for operating a hybrid drive system of a motor vehicle according to the first aspect of the invention. Accordingly, the motor vehicle according to the invention has the advantage over conventional motor vehicles that a regeneration of the exhaust emission control device can be carried out in a cost-effective manner using simple means, and without causing an overload of the traction battery. This is particularly advantageous at a relatively low vehicle speed, for example 40 km/h, 30 km/h, or less, since the exhaust gas temperature thus generated is usually not sufficient for the regeneration, so that it is necessary to apply load to the internal combustion engine. As a result of temporarily refraining from use of the consumers or auxiliary consumers or hybrid driving functions, a power quota is thus reserved for the regeneration, so that an overload of the traction battery due to high battery currents is avoided. In this way, decreased capacity of the traction battery may be lessened, and the service life of the traction battery may be prolonged.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an I-t diagram/s-t diagram of a profile of the effective current value and an associated travel path over time for a motor vehicle according to the prior art,

FIG. 2 shows an I-t diagram/s-t diagram of a profile of the effective current value over time for a motor vehicle according to an example of the invention,

FIG. 3 shows a side view of an example of a motor vehicle according to the invention, and

FIG. 4 shows a flow chart of an example of a method according to the invention.

### DETAILED DESCRIPTION

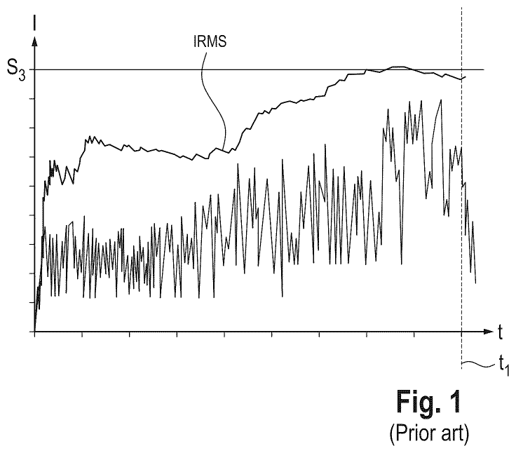

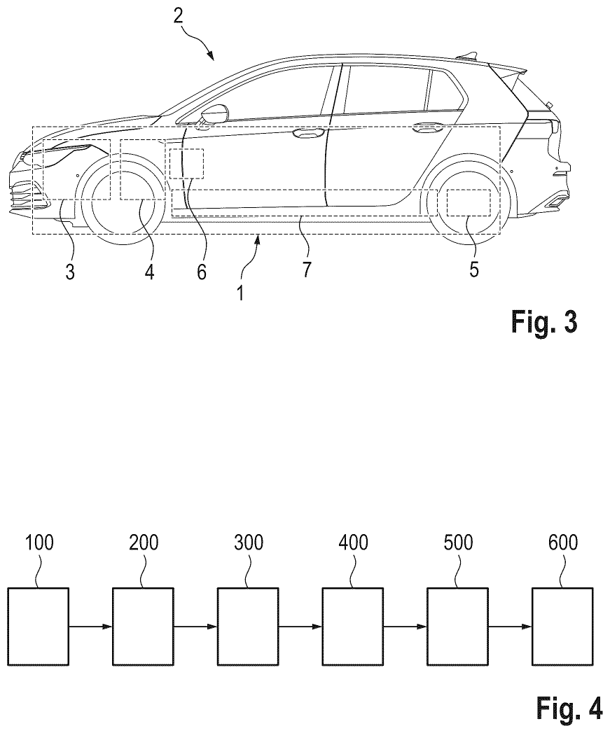

FIG. 1 schematically illustrates the profile of the effective current value (IRMS) over time for a motor vehicle 2 (see FIG. 3) according to the prior art, in an I-t diagram and an s-t diagram. The I-t diagram shows the period of time prior to the regeneration of an exhaust emission control device 5 (see FIG. 3) of the motor vehicle 2. As is clearly apparent from the diagram, the effective current value (IRMS) increases until, at the point in time t₁ of the start of regeneration of the exhaust emission control device 5, it is just below a third current limit value S₃. Thus, applying load to an internal combustion engine 3 (see FIG. 3) of the motor vehicle 2 for regenerating the exhaust emission control device 5 is not possible at the point in time t₁ of the start of regeneration without exceeding the third current limit value S₃ and overloading a traction battery 7 (see FIG. 3) of the motor vehicle 2. The s-t diagram shows the associated travel path of the motor vehicle 2 over time.

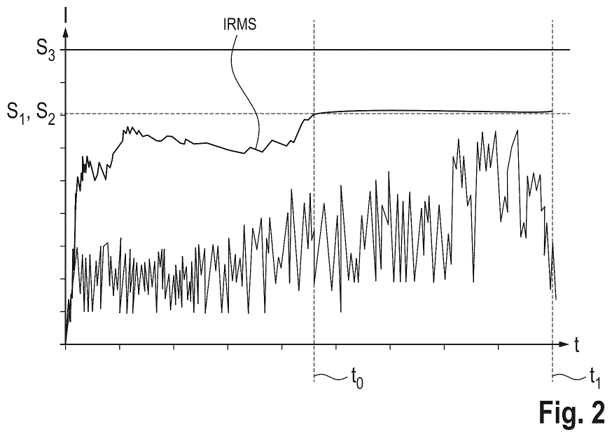

FIG. 2 schematically shows a profile of the effective current value (IRMS) over time for a motor vehicle 2 (see FIG. 3) according to an example of the invention, in an I-t diagram. The s-t diagram shows the associated travel path of the motor vehicle 2 over time. As is clearly apparent from the I-t diagram, the effective current value (IRMS) increases until, at the point in time t₀ of the start of reduction, it reaches a second current limit value S₂ that is lower than the third current limit value S₃. By blocking special operating modes, for example hybrid driving functions of the motor vehicle 2, until the point in time t₁ of the start of regeneration of the exhaust emission control device 5, the effective current value (IRMS) remains at a first current limit value S₁ that corresponds to the second current limit value S₂. A buffer between the effective current value (IRMS) and the third current limit value S₃ is thus provided at the point in time t₁ of the start of regeneration. At the point in time t₁ of the start of regeneration, it is thus possible to apply load to the internal combustion engine 3 (see FIG. 3) of the motor vehicle 2 for regenerating the exhaust emission control device 5 without exceeding the third current limit value S₃ and overloading the traction battery 7 (see FIG. 3) of the motor vehicle 2.

FIG. 3 schematically depicts an example of a motor vehicle 2 according to the invention in a side view. The motor vehicle 2 has a hybrid drive system 1. The hybrid drive system 1 has an internal combustion engine 3 and an electric machine 4 for the drive of the motor vehicle 2. The hybrid drive system 1 has an exhaust emission control device 5 for cleaning the exhaust gases of the internal combustion engine 3. The hybrid drive system 1 has a control device 6 for controlling the hybrid drive system 1. The hybrid drive system 1 has a traction battery for supplying the electric machine 4 with electrical energy.

FIG. 4 schematically shows an example of a method according to the invention in a flow chart. In a first method action 100 the control device 6 of the motor vehicle 2 recognizes an imminent regeneration of an exhaust emission control device 5 of the motor vehicle 2, such as a particulate filter, a catalytic converter, or the like. In a second method action 200 the control device determines the present effective current value (IRMS) of the battery current of the traction battery 7 of the motor vehicle 2, and compares it to the second current limit value S₂. In a third method action 300 the control device 6 reduces the effective current value (IRMS) of the battery current to below the first current limit value S₁ when the present effective current value (IRMS) is greater than the second current limit value S₂.

In a fourth method action 400 the control device 6 carries out the regeneration of the exhaust emission control device 5 by operating the internal combustion engine 3. The control device 6 ensures that the effective current value (IRMS) of the battery current does not exceed the third current limit value S₃. In a fifth method action 500 the control device 6 ends the regeneration of the exhaust emission control device 5. In a sixth method action 600 the control device 6 ends the targeted reduction of the effective current value (IRMS) of the battery current, preferably in such a way that the battery current does not exceed the third current limit value S₃.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating a hybrid drive system of a motor vehicle, the hybrid drive system comprising an internal combustion engine and an electric machine, the method comprising:
recognizing an imminent regeneration of an exhaust emission control device of the motor vehicle by a control device of the motor vehicle;
determining a present effective current value of a battery current of a traction battery of the motor vehicle by the control device;
targeted reducing the effective current value of the battery current to below a first current limit value by the control device when the present effective current value exceeds a second current limit value;
performing the regeneration of the exhaust emission control device by operating the internal combustion engine via the control device such that as a result of the effective current value of the battery current, a third current limit value is not exceeded, the third current limit value being higher than the second current limit value;
ending the regeneration of the exhaust emission control device by the control device; and
ending the targeted reduction of the effective current value of the battery current by the control device.

2. The method according to claim 1, wherein a first current limit value is used which is less than or equal to the second current limit value.

3. The method according to claim 1, wherein a second current limit value is used which corresponds to between 50% and 75% of the third current limit value.

4. The method according to claim 1, wherein for the targeted reduction of the effective current value of the battery current by the control device, a recuperation is completely or at least partially prevented when a state of charge of the traction battery is greater than a predefined state of charge threshold value of the traction battery.

5. The method according to claim 1, wherein for the targeted reduction of the effective current value of the battery current, a load point shift of the internal combustion engine is completely or at least partially suppressed by the control device.

6. The method according to claim 1, wherein for the targeted reduction of the effective current value of the battery current, a transient compensation of the electric machine for the internal combustion engine is completely or at least partially suppressed by the control device.

7. The method according to claim 1, wherein the first current limit value is determined by the control device as a function of traffic data in the surroundings of the motor vehicle.

8. The method according to claim 1, wherein the first current limit value is determined by the control device as a function of data from a navigation system of the motor vehicle.

9. The method according to claim 1, wherein the first current limit value is determined by the control device as a function of driving statistics of the motor vehicle and/or of a driver of the motor vehicle.

10. A motor vehicle comprising:
a hybrid drive system comprising an internal combustion engine to drive the motor vehicle and an electric machine to drive of the motor vehicle,
wherein the motor vehicle is designed to carry out the method according to claim 1.
